(19) United States
(12) Patent Application Publication
(10) Pub. No.: US 2023/0114448 A1
(43) Pub. Date: Apr. 13, 2023

(54) VEHICLE AND METHOD OF CONTROLLING THE SAME

(71) Applicants: Hyundai Motor Company, Seoul (KR); Kia Corporation, Seoul (KR)

(72) Inventor: Junghei Ryu, Seoul (KR)

(21) Appl. No.: 17/959,753

(22) Filed: Oct. 4, 2022

(30) Foreign Application Priority Data
Oct. 13, 2021 (KR) 10-2021-0135604

(51) Int. Cl. G07C 5/00; H04L 12/40

(52) U.S. Cl. CPC G07C 5/008; H04L 12/40006; H04L 2012/40215; H04L 2012/40273

(57) ABSTRACT

A vehicle according to an exemplary embodiment of the disclosure is capable of detecting and responding to vehicle hacking. The vehicle may comprise a communication device configured to perform internal communication of a vehicle or communication between the vehicle and an external server, a plurality of Electronic Control Units (ECUs), a memory configured to store a criterion for determining whether hacking has occurred in the vehicle; a processor that collects data from the plurality of ECUs and analyzes the data to determine whether the data is unidentified data or whether hacking has occurred in the vehicle, and the communication device may transmit the data to the external server in response to determining that the data is unidentified data.

### CROSS-REFERENCE TO RELATED APPLICATION(S)

This application claims, under 35 U.S.C. § 119(a), the benefit of priority to Korean Patent Application Nos. 10-2021-0135604, filed on Oct. 13, 2021 in the Korean Intellectual Property Office, the disclosure of which is incorporated herein by reference in its entirety.

### BACKGROUND

### Technical Field

Embodiments of the present disclosure relate to a vehicle and method of controlling the same capable of determining whether the vehicle is hacked and responding thereto.

### Description of the Related Art

In general, x.ipscv is a standard that describes a vehicle hacking detection and a response method thereof. As described in x.ipscv, when a hacking penetration into a vehicle is detected, a response thereto is required.

Existing in-vehicle internal networks are not designed in consideration of an in-vehicle internal network structure and a network routing method for emergency response. Conventionally, only detection of a vehicle hacking is performed, and a specific method for responding thereto after the detection of the hacking is not provided.

Furthermore, when unidentified data that is not data pre-stored in an in-vehicle memory during vehicle design penetrates, the vehicle may not determine by itself whether the vehicle is hacked and thus fails to immediately respond to the hacking.

### SUMMARY

An aspect of the present disclosure is to provide a vehicle capable of immediately responding to hacking caused by unidentified data that is not previously stored by transmitting the unidentified data to an external server and determining whether hacking has occurred, and a method of controlling the same.

Additional aspects of the present disclosure will be set forth in part in the description which follows and, in part, will be obvious from the description, or may be learned by practice of the present disclosure.

In accordance with an aspect of the present disclosure, a vehicle may comprise a communication device configured to perform an internal communication of a vehicle or a communication between the vehicle and an external server; a plurality of Electronic Control Units (ECUs); a memory configured to store a criterion for determining whether a hacking has occurred in the vehicle; and a processor configured to collect data from the plurality of ECUs and analyze the collected data to determine whether the collected data is unidentified data or whether the hacking has occurred in the vehicle; wherein the communication device may be configured to transmit the collected data to the external server in response to determining that the collected data is the unconfirmed data.

The processor may be configured to determine that the collected data is the unidentified data, in the case that the collected data is not included in predetermined data stored in the memory.

The communication device may be configured to receive a hacking occurrence message and a response instruction from the external server when the external server determines that the hacking has occurred in the vehicle by analyzing the received unidentified data from the communication device.

The communication device may be configured to transmit the response instruction to the processor, in response to receiving the hacking occurrence message and the response instruction from the external server.

The processor may be configured to transmit a control signal to the plurality of ECUs to perform the received response instruction in response to receiving the response instruction from the communication device.

The response instruction may comprise at least one of alerting a driver, parking on a shoulder, moving to a service center, or updating at least one of the plurality of ECUs.

The communication device and the processor may be configured to use at least one of a Controller Area Network (CAN) communication or an Ethernet communication, for the communication device to transmit the response instruction to the processor and for the processor to transmit the control signal to the plurality of ECUs.

By applying a Routing protocol to either the CAN communication or the Ethernet communication, the communication device may be configured to transmit the response instruction to the processor and the processor may be configured to transmit the control signal to the plurality of ECUs.

Method of controlling a vehicle according to an exemplary embodiment of the present disclosure may comprise collecting data from a plurality of ECUs; analyzing the collected data based on a criterion stored in a memory and determining whether the collected data is unidentified data or whether a hacking has occurred in the vehicle; and transmitting the collected data to an external server in response to determining that the collected data is the unidentified data.

Method of controlling the vehicle may further comprise determining that the collected data is the unidentified data, in the case that the collected data is not included in predetermined data stored in the memory.

Method of controlling the vehicle may further comprise receiving a hacking occurrence message when the external server analyzes the received unidentified data and determines that the hacking has occurred in the vehicle; and transmitting the response instruction to a processor when a communication device receives the hacking occurrence message and the response instruction from the external server.

The response instruction may comprise at least one of alerting a driver, parking on a shoulder, moving to a service center, or updating at least one of the plurality of ECUs.

Transmitting the response instruction and the control signal may be configured to use at least one of Controller Area Network (CAN) communication or Ethernet communication.

Method of controlling the vehicle may further comprise transmitting the response instruction and the control signal by applying a Routing protocol to the at least one of the CAN communication or the Ethernet communication.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a control block diagram for internal communication of a vehicle and communication between a vehicle and an external server according to an exemplary embodiment of the present disclosure;

FIG. 2 is a flowchart illustrating a process in which a processor analyzes data collected from an ECU according to an exemplary embodiment of the present disclosure;

FIG. 3 is a control block diagram illustrating a process in which a signal is transmitted from an external server to an ECU according to an exemplary embodiment of the present disclosure;

FIG. 4 is a diagram illustrating that internal communication of a vehicle is performed according to an exemplary embodiment of the present disclosure; and

FIGS. 5 to 7 are flowcharts showing a method of a vehicle responding hacking according to an exemplary embodiment of the present disclosure.

### DETAILED DESCRIPTION

Like reference numerals refer to like elements throughout the specification. Not all elements of the embodiments of the present disclosure will be described, and the description of what are commonly known in the art or what overlap each other in the exemplary embodiments will be omitted. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

The terms “include (or including)” and “comprise (or comprising)” are inclusive or open-ended and do not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure. Reference numerals used for method steps are merely used for convenience of explanation, but not to limit an order of the steps. Thus, unless the context clearly dictates otherwise, the written order may be practiced otherwise.

It is to be understood that the singular forms “a,” “an,” and “the” include plural references unless the context clearly dictates otherwise.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a non-transitory computer-readable recording medium.

The non-transitory computer-readable recording medium may include all types of recording media storing instructions that may be interpreted by a computer. For example, the non-transitory computer-readable recording medium may be, for example, Read Only Memory (ROM), Random Access Memory (RAM), a magnetic tape, a magnetic disc, flash memory, an optical data storage device, and the like.

Hereinafter, according to an aspect of a vehicle and method of controlling the vehicle embodiments of the present disclosure will be described with reference to accompanying drawings.

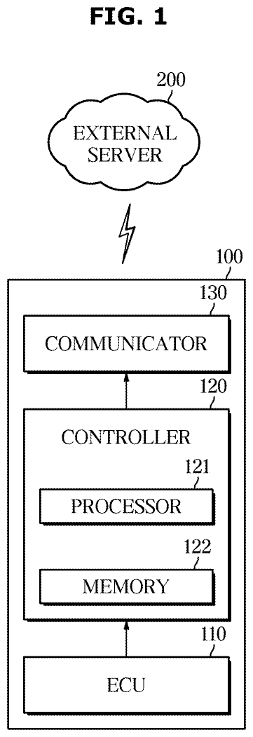

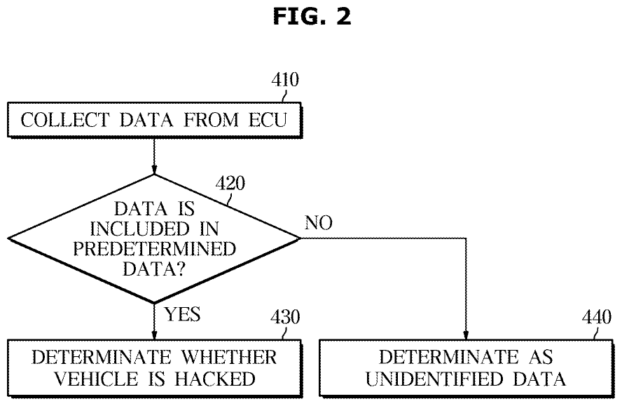

FIG. 1 is a block diagram for internal communication of a vehicle and communication between a vehicle and an external server, and FIG. 2 is a flowchart illustrating a process in which a processor analyzes collected data from an electronic control unit (ECU).

Referring to FIGS. 1 and 2, a vehicle 100 may comprise a plurality of ECUs 110, a controller 120, and a communication device 130, and the controller 120 may comprise a processor 121 and a memory 122.

The ECU 110 is a control unit capable of controlling various electric control devices such as an engine, a transmission, an airbag control, and a tire air pressure inside the vehicle 100.

Various data may exist in each of the plurality of ECUs 110, and the ECU 110 may be configured to transmit each data to the processor 121 to determine whether the data is normal data or abnormal data for attempting vehicle hacking.

The controller 120 may comprise the memory 122 in which a program for performing an operation to be described later is stored and the processor 121 for executing the stored program. The controller 120 may comprise at least one memory and at least one processor. A memory and a processor may be integrated on one chip or be physically separated.

The processor 121 may be configured to collect data from each of the plurality of ECUs 110.

The processor 121 may be configured to analyze the data collected from the ECU 110 and determine whether hacking has occurred in a vehicle or whether the collected data is unidentified data.

The memory 122 may be configured to store a criterion for the processor 121 to determine whether hacking has occurred in a vehicle, and the processor 121 may be configured to analyze collected data from the ECU 110 based on the data stored in the memory 122.

The memory 122 may comprise a volatile memory such as Static Random Access Memory (S-RAM) and Dynamic Random Access Memory (D-RAM), and include a non-volatile memory such as ROM and Erasable Programmable Read Only Memory (EPROM). A memory 122 may comprise one memory device or a plurality of memory devices.

The communication device 130 may be configured to transmit and receive data by performing internal communication of a vehicle or communicating with the external server 200.

When the processor 121 analyzes the data collected from the ECU 110 and determines that the collected data is unidentified data that is not stored in the memory 122, the communication device 130 may be configured to receive the data and transmit the data to the external server 200.

Referring to FIG. 2, the processor 121 may be configured to collect data from each of the plurality of ECUs 110 (410).

The processor 121 may be configured to determine whether the data collected from the ECU 110 is included in predetermined data stored in the memory 122.

When the processor 121 determines that the collected data is included in the predetermined data (Yes in 420), the processor 121 may be configured to determine by itself whether or not hacking has occurred in a vehicle based on the predetermined data (430). That is, the processor 121 may be configured to determine whether or not the vehicle has been hacked by itself inside the vehicle 100 without relying on the external server 200.

When the processor 121 determines that the collected data is not included in the predetermined data (No in 420), the processor 121 may be configured to determine that the collected data is unidentified data (440).

As described above, when the processor 121 determines that the analyzed data is unidentified data, because the vehicle may not determine whether a vehicle has been hacked by itself inside the vehicle, the communication device 130 may be configured to transmit the unidentified data to the external server 200.

The external server 200 has a larger amount of data than the predetermined data stored in the vehicle 100 and may be configured to analyze the unidentified data that the processor 121 may not determine regarding vehicle hacking, and may be configured to determine whether hacking has occurred in the vehicle 100 based thereon.

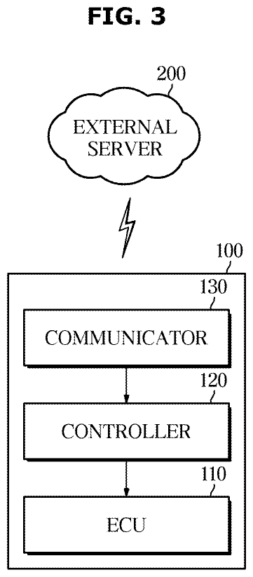

FIG. 3 is a control block diagram illustrating a process in which a signal is transmitted from an external server to an ECU.

Referring to FIG. 3, when the external server 200 determines that hacking has occurred in the vehicle 100 as a result of analyzing the received unidentified data, the external server 200 may be configured to transmit a hacking occurrence message and a response instruction to the communication device 130 of the vehicle 100.

When receiving the hacking occurrence message and the response instruction from the external server 200, the communication device 130 may be configured to transmit the response instruction to the processor 121 in order to respond to vehicle hacking.

Because hacking of the vehicle 100 may be performed in various ways, a response method may also be provided in various ways.

For example, a response instruction may comprise at least one of a driver alert notifying a driver of a hacking occurrence, controlling the vehicle 100 to be parked on a shoulder, moving the vehicle 100 to a service center, or updating at least one of the plurality of ECUs 110.

The response instruction is not limited to the above described, and any method may be used to respond to hacking of a vehicle.

When the processor 121 receives the response instruction from the communication device 130, the processor 121 may be configured to transmit a control signal to the plurality of ECUs 110 to perform the response instruction.

Each of the plurality of ECUs 110 may be configured to control a device according to the received control signal to perform the above-mentioned response.

Only one ECU 110 may be configured to perform the above response, or a plurality of ECUs 110 may be configured to cooperate to perform the above response.

An internal communication network of the vehicle 100 may be used to transmit the response instructions and control signals as described above. The process of transmitting data by using the internal communication network will be described in detail below.

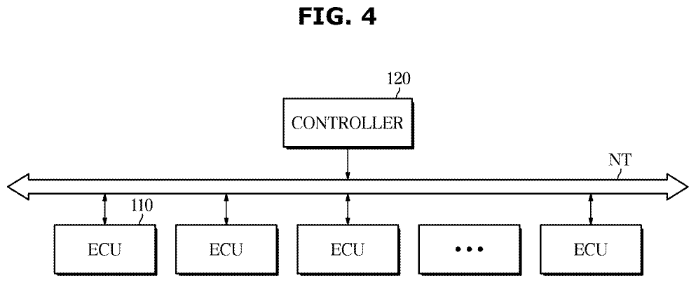

FIG. 4 is a diagram illustrating that internal communication of a vehicle is performed.

When the communication device 130 transmits the response instruction to the processor 121 and the processor 121 transmits the control signal to the plurality of ECUs 110, the internal communication network of a vehicle may be used.

During internal communication of the vehicle 100, communication may be performed using a network such as Controller Area Network (CAN) communication, FlexRay, Ethernet, or Local Interconnect Network (LIN).

Among these, CAN communication or Ethernet communication is used for internal communication of the vehicle 100 in the present disclosure, and the description will be limited thereto.

CAN communication is a communication standard designed for microcontrollers or devices to communicate with each other in a vehicle without a host computer. CAN communication is a message-based protocol, and recently, CAN communication is often used not only in a vehicle but also in industrial automation devices and medical equipment. CAN is a non-host bus type and message-based network protocol mainly used for communication between controllers.

Ethernet communication refers to a network structure in which wired/wireless communication equipment on one Internet line is connected to a LAN line and a communication port through a router, a hub, etc. to enable communication.

When the internal communication of the vehicle 100, that is, the communication device 130 transmits a response instruction to the processor 121 or the processor 121 transmits a control signal to the ECU 110, CAN communication or Ethernet communication as described above may be used.

In addition, in order to transmit and receive data through a more optimized path, a Routing Protocol may be applied during CAN communication or Ethernet communication.

A Routing is a process of selecting an optimal path when sending communication data in a network. The optimal path is a path that may be configured to transmit given data over the shortest distance or in the least amount of time. The Routing is used in various types of networks, such as telephone networks, electronic information networks, and transportation networks.

A Routing protocol is a communication protocol that defines a method of such communication.

According to the embodiment of the present disclosure, communication data may be transmitted and received through a more optimized path by applying a Routing protocol to CAN or Ethernet used for internal communication of the vehicle 100.

More particularly, a CAN network may not have a separate Routing Table, and a CAN Identification (ID) for emergency response may be newly defined. An ECU may be configured to perform instructions using a corresponding CAN ID.

In the case of an Ethernet network, routing information with high priority may be input so that emergency data may be prioritized on an Ethernet Routing Table.

As described above, according to the present disclosure, the vehicle 100 transmits unidentified that may not be determined by the vehicle itself to the external server 200 to respond to penetration by unidentified data. Also during internal communication of the vehicle 100, a more immediate response to vehicle hacking may be achieved by transmitting and receiving data through an optimized route by applying a routing protocol to the communication network.

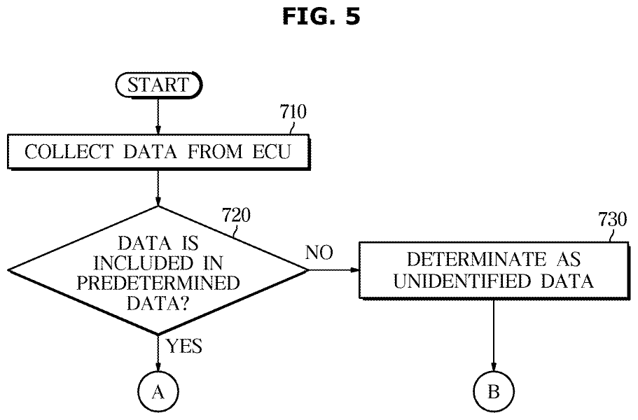

FIGS. 5 to 7 are flowcharts related to a vehicle hacking prevention method.

Referring to FIG. 5, the processor 121 may be configured to collect data from the plurality of ECUs 110 (710).

In addition, the processor may be configured to determine whether the collected data is included in predetermined data stored in the memory 122.

When the data collected from the ECU 110 is included in the predetermined data (YES in 710), the vehicle 100 may be configured to determine by itself whether the vehicle 100 has been hacked.

When the collected data from the ECU 110 is not included in the predetermined data (No in 710), the data may be determined as unidentified data. In this case, because the vehicle 100 may not determine by itself whether the vehicle 100 has been hacked, the unidentified data may be transmitted to the external server 200.

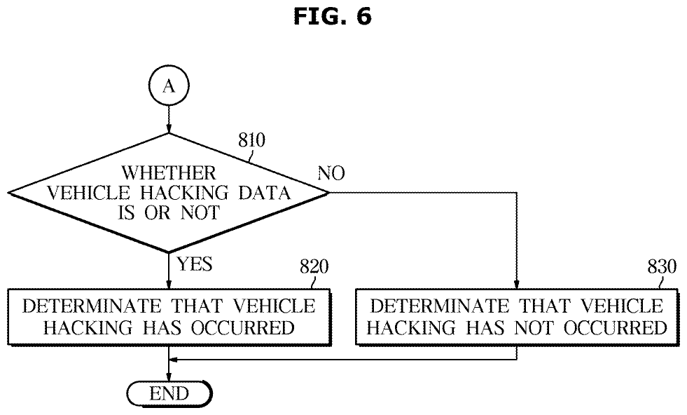

Referring to FIG. 6, the processor 121 of the vehicle 100 may be configured to determine whether data collected from the ECU 110 is vehicle 100 hacking data.

When the processor 121 determines that the data is vehicle 100 hacking data by analyzing the collected data (YES in 810), the processor 121 may be configured to determine that the vehicle hacking has occurred (820).

When the processor 121 determines that the vehicle hacking has occurred, a response to the vehicle hacking may be performed by controlling the plurality of ECUs 110 in order to respond thereto.

When the processor 121 determines that data is not vehicle 100 hacking data by analyzing the collected data (No in 810), the processor 121 may be configured to determine that the vehicle hacking has not occurred (830).

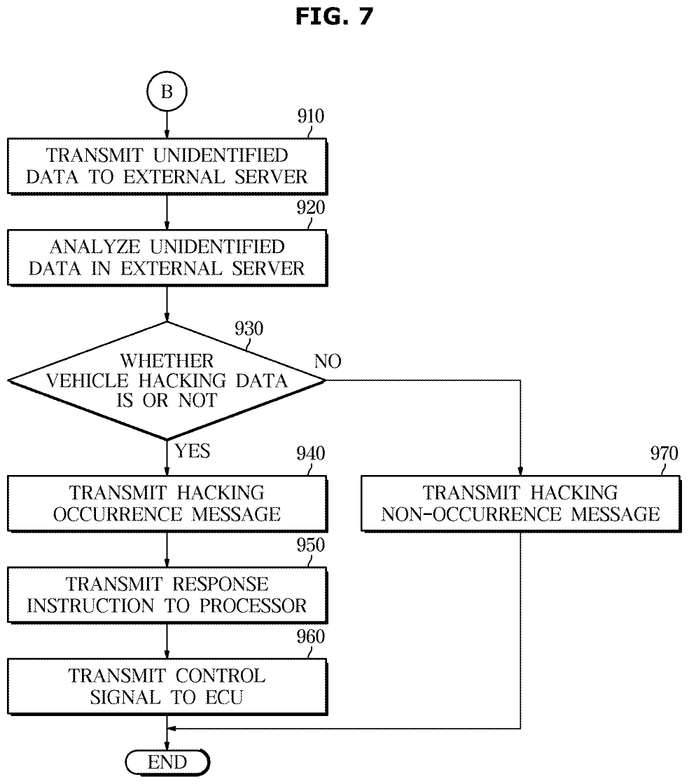

Referring to FIG. 7, in response to determining that the data collected from the ECU 110 is unidentified data, the unidentified data may be transmitted to the external server 200 (910).

The external server 200 may be configured to determine whether to be hacked based on a larger amount of data than data of the memory 122 of the vehicle 100.

The external server 200 may be configured to determine whether hacking has occurred in the vehicle 100 by analyzing the received unidentified data (920).

More particularly, the external server 200 may be configured to determine whether the received unidentified data is vehicle hacking data.

When the external server 200 analyzes the unidentified data and determines that the unidentified data is not vehicle hacking data (No in 930), the external server 200 may be configured to transmit a hacking non-occurrence message to the communication device 130 indicating that hacking has not occurred (970).

When the external server 200 analyzes the unidentified data and determines that the unidentified data is vehicle hacking data (Yes in 930), the external server 200 may be configured to transmit a hacking occurrence message and a response instruction to the communication device 130 indicating that hacking has occurred (940).

When the communication device 130 receives the hacking occurrence message and the response instruction from the external server 200, the communication device 130 may be configured to transmit the response instruction to the processor 121 in order to respond to the hacking (950).

Because hacking of the vehicle 100 may be performed in various ways, a response method may also be provided in various ways.

For example, a response instruction may comprise at least one of a driver alert notifying a driver of a hacking occurrence, controlling the vehicle 100 to be parked on a shoulder, moving the vehicle 100 to a service center, or updating at least one of the plurality of ECUs 110.

When receiving the response instruction from the communication device 130, the processor 121 may be configured to transmit a control signal corresponding to the response instruction to the plurality of ECUs 110.

Each of the plurality of ECUs 110 may be configured to control a device according to the received control signal to perform the above-mentioned response.

Only one ECU 110 may be configured to perform the above response, or the plurality of ECUs 110 may be configured to cooperate to perform the above response.

In the case of internal communication of a vehicle for transmitting the response instruction or the control signal, at least one of CAN communication and Ethernet communication may be used.

A Routing Protocol may be applied to at least one of CAN communication or Ethernet communication in order to transmit and receive communication data through a more optimized path.

As is apparent from the above, embodiments of the present disclosure may provide a vehicle and a method of controlling a vehicle capable of responding to vehicle hacking due to unconfirmed data that is not stored in a memory during vehicle design, and more immediate response may be made by transmitting and receiving communication data through an optimized path.

Embodiments of the present disclosure have thus far been described with reference to the accompanying drawings. It should be apparent to those of ordinary skill in the art that the present disclosure may be practiced in other forms than the embodiments as described above without changing the technical idea or essential features of the present disclosure. The above embodiments are only by way of example, and should not be interpreted in a limited sense.

What is claimed is:

1. A vehicle, comprising:
a communication device configured to perform:
an internal communication of a vehicle; or
a communication between the vehicle and an external server;
a plurality of electronic control units (ECUs);
a memory configured to store a criterion for determining whether a hacking has occurred in the vehicle; and
a processor configured to:
collect data from the plurality of ECUs; and
analyze the data to determine whether the data is unidentified data or whether the hacking has occurred in the vehicle,
wherein the communication device is further configured to transmit the data to the external server in response to determining that the data is the unidentified data.

2. The vehicle of claim 1, wherein the processor is further configured to determine that the data is the unidentified data if the data is not included in predetermined data stored in the memory.

3. The vehicle of claim 2, wherein the communication device is further configured to receive a hacking occurrence message and a response instruction from the external server, when the external server determines that the hacking has occurred in the vehicle by analyzing the unidentified data received from the communication device.

4. The vehicle of claim 3, wherein the communication device is further configured to transmit the response instruction to the processor in response to receiving the hacking occurrence message and the response instruction from the external server.

5. The vehicle of claim 4, wherein the processor is further configured to transmit a control signal to the plurality of ECUs in order cause the plurality of ECUs to perform the received response instruction in response to receiving the response instruction from the communication device.

6. The vehicle of claim 5, wherein the response instruction comprises one or more of the following: alerting a driver; parking on a shoulder; moving to a service center; and updating at least one of the plurality of ECUs.

7. The vehicle of claim 6, wherein:
the communication device is further configured to use at least one of a controller area network (CAN) communication or an Ethernet communication to transmit the response instruction to the processor, and
the processor is further configured to use the at least one of CAN communication or Ethernet communication to transmit the control signal to the plurality of ECUs.

8. The vehicle of claim 7, wherein:
by applying a Routing protocol to either the CAN communication or the Ethernet communication, the communication device is further configured to transmit the response instruction to the processor, and
the processor is further configured to transmit the control signal to the plurality of ECUs.

9. A method of controlling a vehicle, the method comprising:
collecting data from a plurality of electronic control units (ECUs);
analyzing the data based on a criterion stored in a memory;
determining whether the data is unidentified data or whether a hacking has occurred in the vehicle; and
transmitting the data to an external server in response to determining that the data is the unidentified data.

10. The method of claim 9, further comprising determining that the data is the unidentified data when the collected data is not included in predetermined data stored in the memory.

11. The method of claim 10, further comprising:
receiving a hacking occurrence message and a response instruction from the external server, when the external server analyzes the received unidentified data and determines that the hacking has occurred in the vehicle; and
transmitting the response instruction to a processor, when a communication device receives the hacking occurrence message and the response instruction from the external server.

12. The method of 11, further comprising transmitting a control signal to the plurality of ECUs in order to cause the plurality of ECUs to perform the received response instruction when the processor receives the response instruction.

13. The method of claim 12, wherein the response instruction comprises one or more of the following: alerting a driver; parking on a shoulder; moving to a service center; and updating at least one of the plurality of ECUs.

14. The method of claim 13, wherein, when transmitting the response instruction, the control signal uses at least one of Controller Area Network (CAN) communication or Ethernet communication.

15. The method of claim 14, further comprising transmitting the response instruction and the control signal by applying a Routing protocol to the at least one of the CAN communication or the Ethernet communication.
